(19) United States
(12) Patent Application Publication
(10) Pub. No.: US 2026/0009202 A1
(43) Pub. Date: Jan. 8, 2026

(54) WINDSCREEN GUARD ASSEMBLY FOR A WORKING MACHINE

(71) Applicant: J.C BAMFORD EXCAVATORS LIMITED, Uttoxeter (GB)

(72) Inventors: Jaydeep Walke, New Delhi (IN); Mahesh Patil, New Delhi (IN); Stuart Jones, Uttoxeter (GB)

(21) Appl. No.: 19/260,197

(22) Filed: Jul. 3, 2025

(30) Foreign Application Priority Data
Jul. 4, 2024 (IN) 202411051438
Aug. 27, 2024 (GB) 2412514.8

(51) Int. Cl. E02F 9/16

(52) U.S. Cl. CPC E02F 9/163

(57) ABSTRACT

A working machine that includes a chassis and an operator cabin mounted to the chassis. The operator cabin includes a primary windscreen and a secondary windscreen adjacent to the primary windscreen. Further, the working machine includes a primary grill segment to cover the primary windscreen and a secondary grill segment to cover the secondary windscreen. The primary grill segment is fixedly mounted to the operator cabin and the secondary grill segment is pivotably mounted to the operator cabin to uncover the secondary windscreen in an open position and cover the secondary windscreen in a closed position.

### TECHNICAL FIELD

The subject matter described herein in general relates to windscreen guard assembly, and, in particular, to a windscreen guard assembly for a working machine.

### BACKGROUND

Working machines, such as backhoe loaders, slew excavators, telescopic handlers, forklifts, and skid-steer loaders, may be employed in construction industries or otherwise for moving loads. A working machine may include a chassis and an operator cabin mounted on the chassis. The working machine may further have a working arm, also referred to as a boom, movably mounted to a body of the working machine, for example, on the chassis of the working machine or on the operator cabin. The operator cabin may be equipped with control devices, for example, joystick, steering assembly, and driving pedals, for controlling the various operations of the working machine and its attachments. An operator may control the various control devices to operate the working machine. The operator cabin may be an enclosed structure to protect the operator from being exposed to external environments, for example, preventing weather, dirt, or debris from entering the working machine. Further, the operator cabin is provided with windows, for example, a front windscreen and side windscreens, to allow the operator to view the surroundings while operating the working machine.

### SUMMARY OF THE INVENTION

The subject matter described herein is directed towards a windscreen guard assembly for a working machine.

According to a first aspect of the present teachings, there is provided a working machine. The working machine comprises a chassis, and an operator cabin mounted to the chassis. The operator cabin comprises a primary windscreen and a secondary windscreen adjacent to the primary windscreen. The working machine further comprises a primary grill segment to cover the primary windscreen and a secondary grill segment to cover the secondary windscreen. The primary grill segment may be fixedly mounted to the operator cabin. Further, the secondary grill segment may be pivotably mounted to the operator cabin to uncover the secondary windscreen in an open position and cover the secondary windscreen in a closed position.

Advantageously, the above-mentioned working machine has a modular structure for the windscreen guard assembly. Accordingly, each component, inclusive of, primary grill segment and the secondary grill segment, may be manufactured as separate components and may be separately mounted on the working machine. Therefore, smaller size components are to be mounted on the working machine allowing for ease in assembly and installation of the windscreen guard assembly on the working machine. Further, the pivotable mounting of the secondary grill segment on the operator cabin may allow easy access to the secondary windscreen and the primary windscreen through the secondary windscreen.

The secondary grill segment may comprise a handle to operate the secondary grill segment between the open position and the closed position with respect to the primary grill segment. Advantageously, the handle may be operable by an operator to allow the operator to open, close, or otherwise manipulate the secondary grill segment. The handle may transmit force that may be applied by the operator to manipulate the secondary grill segment between the open position and the closed position.

The handle may be formed as a loop member retractable with respect to the secondary grill segment. Advantageously, the loop configuration provides an easily graspable element, potentially improving comfort and reducing strain during operation. Further, the handle being retractable may provide a compact and streamlined profile when the handle is not in use, thereby reducing protrusions and potential snag points. When needed, the loop member can be extended to offer a large, ergonomic gripping surface.

The handle may be provided at a distal edge of the secondary grill segment. The distal edge may be an edge of the secondary grill segment away from an edge that is to pivotably mount the secondary grill segment to the operator cabin. Advantageously, by providing the handle at the distal edge, the moment of torque transmitted to the pivotable mounting may be high for allowing easy pivoting of the secondary grill segment between the open and the closed position. As a result, the operator may have to provide less torque on the handle than needed for pivoting the secondary grill segment if the handle were provided in proximity to the edge of pivotable mounting.

The handle may be coupled to the secondary grill segment at a lower edge thereof. The lower edge may be an edge of the secondary grill segment in proximity to the chassis. Advantageously, by providing the handle at the lower edge of the secondary grill segment, the operator may easily grasp the handle while standing on the ground and without climbing upon an elevated structure to access the secondary grill segment.

The primary grill segment and the secondary grill segment may comprise a bump stopper positioned at an interface therebetween. Advantageously, the bump stopper may act as a cushioning mechanism, absorbing shock and reducing wear on the interface of the primary grill segment and the secondary grill segment. The bump stopper may significantly extend the lifespan of the primary grill segment and the secondary grill segment by minimizing mechanical stress and potential damage from repeated opening and closing of the secondary grill segment. The bump stopper may also provide a defined limit to the range of motion of the secondary grill segment, preventing the secondary grill segment from hitting one of the primary windscreen and secondary windscreen. Additionally, the bump stopper may aid in retaining the secondary grill segment in the closed position during operation of the working machine and allows maintaining accurate positioning or alignment of the secondary grill segment with respect to the primary grill segment.

A vertical dimension of the secondary grill segment may be less than a vertical dimension of the primary grill segment. The vertical dimension may be measured along a direction of offset between points of pivotable mounting between the secondary grill segment and the operator cabin. Advantageously, the smaller vertical segment may allow space for installing rear view mirrors on the operator cabin and also provide a clear view of the rear view mirrors to the operator.

The secondary grill segment may include a grated structure to substantially cover the secondary windscreen in the closed position of the secondary grill segment.

The grated structure may include a connecting section and a grill section offset from the connecting section. The connecting section may pivotably mount the secondary grill segment to the operator cabin. Further, the grill section may include a mesh of spaced and interconnected elongated bars arranged to form a grid structure to cover the secondary windscreen in the closed position. Advantageously, providing the grill section allows robust protection for the windscreen against impacts from debris while maintaining operator's field of view which is crucial for safe and efficient operation.

An edge of the grill section may be offset from an edge of the connecting section. Advantageously, providing the edge of grill section offset from the connecting section allows a wider visibility for the operator. Further, the edge of the grill section being offset from the connecting section allows for a smaller grill section substantially covering the secondary windscreen and having a reduced weight.

The primary grill segment may be coupled to the operator cabin through a plurality of mounting brackets positioned at an upper edge and a lower edge thereof. The mounting brackets may be engageable with the operator cabin for fixedly mounting the primary grill segment to the operator cabin.

The mounting brackets may be integrated with the primary grill segment and may be laterally distributed at the upper edge of the primary grill segment. Advantageously, the lateral distribution provides improved stability and load distribution across a wider area thereby allowing balanced mounting of the primary grill segment on the operator cabin. Further, the mounting bracket may increase the space between the primary windscreen and the primary grill segment to allow the primary windscreen to be easily accessed from the secondary windscreen.

The primary grill segment may include a cut-out formed at each upper corner thereof. Advantageously, the cut-out may allow positioning of headlamps on the operator cabin.

The secondary grill segment may comprise a weight-distribution structure contiguous to the grated structure. The weight-distribution structure may be designed and positioned with respect to the grated structure to regulate a position of a center of gravity (CG) of the secondary grill segment. Advantageously, controlling a position of the CG may provide the flexibility of providing the CG in proximity to a point from where an operator may grasp the secondary grill segment, facilitating easier pivoting between the open position and the closed position. As a result, an operator can easily access the secondary windscreen behind the secondary grill segment for regular cleaning and maintenance.

A mass of the weight-distribution structure may be greater than a mass of the grated structure. Advantageously, the greater mass of the weight-distribution structure influences the CG to be positioned in proximity of the weight-distribution structure. Thus, the greater mass of the weight-distribution structure allows regulating the CG.

The weight-distribution structure may bias the secondary grill segment in the closed position. Advantageously, the secondary grill segment being biased in the closed position may prevent accidental opening of the secondary grill segment during operation of the working machine.

The secondary grill segment may comprise a handle. The handle may be coupled to the weight-distribution structure.

The handle may be positioned in proximity to the CG of the secondary grill segment. Advantageously, the handle may be grasped and used by the operator to pivot the secondary grill segment. Providing the handle on the weight-distribution structure and in proximity to the CG, allows the pivoting of secondary grill segment to be achieved with low rotational torque.

The weight-distribution structure may include a panel.

The panel may comprise a perforated configuration.

The secondary grill segment may be detachably engageable with the operator cabin by a fastening mechanism. The fastening mechanism may be provided between the weight-distribution structure and the operator cabin. Advantageously, the fastening mechanism may allow the secondary grill segment to be retained in the closed position during operation of the working machine and accidental opening of the secondary grill segment may be prevented. Further, the fastening mechanism being provided on the weight-distribution structure may prevent bending of the secondary grill segment as the point of fastening would be in proximity to the CG of the secondary grill segment. Additionally, the weight-distribution structure is designed to be positioned in proximity to a location where an operator operates the secondary grill segment. Therefore, providing the fastening mechanism on the weight-distribution structure would ensure easy accessibility for the operator for fastening.

The fastening mechanism may be provided in proximity to a handle of the secondary grill segment. Advantageously, the threaded member may be easily accessed by an operator for fastening/unfastening the weight-distribution structure and the operator cabin.

The fastening mechanism may be provided on the secondary grill segment at a lower edge thereof. The lower edge may be an edge of the secondary grill segment in proximity to the chassis. Advantageously, the fastening mechanism may be easily accessed and operated by an operator for fastening/unfastening without climbing an elevated structure.

The fastening mechanism may comprise a threaded member and a threaded receptacle. The threaded member may be rotatably insertable through the weight-distribution structure and the operator cabin. Further, the threaded member may engage with threads of the threaded receptacle for securely fastening the weight-distribution structure and the operator cabin. The threaded receptacle may be provided on at least one of the weight-distribution structure and the operator cabin.

The threaded member may comprise a gripping member connected at a head of the threaded member for rotation of the threaded member with respect to the threaded receptacle. Advantageously, the threaded member may be easily held by an operator for fastening/unfastening the weight-distribution structure and the operator cabin.

The secondary grill segment may be pivotably mounted to the operator cabin by a hinge assembly. The hinge assembly may include a first hinged coupling and a second hinged coupling. The first hinged coupling may be provided between the grated structure and the operator cabin. The first hinged coupling may include a first hinge body coupled to the grated structure and a first receiving bracket on the operator cabin. The first receiving bracket receives the first hinge body. The second hinged coupling may be provided between the weight-distribution structure and the operator cabin. The second hinged coupling may include a second hinge body coupled to the weight-distribution structure and a second receiving bracket on the operator cabin. The second receiving bracket receives the second hinge body.

The CG of the secondary grill segment may be regulated to be positioned between the second hinge body and a midpoint between the first hinge body and the second hinge body.

The secondary grill segment may be pivotably mounted to the operator cabin through an intermediate structure on the operator cabin. The hinge assembly may be provided on the intermediate structure.

The first receiving bracket and the second receiving bracket may be provided on the intermediate structure.

According to a second aspect of the present teachings, there is provided a windscreen guard assembly. The windscreen guard assembly may include a frame, a primary grill segment, and a secondary grill segment. The frame may be mountable to an operator cabin of a working machine. The primary grill segment may be formed in a first portion of the frame and may be fixedly mounted to the frame. The primary grill segment may cover a primary windscreen in a mounted state of the frame. A secondary grill segment may be disposed in a second portion of the frame. The secondary grill segment may be pivotably mounted to the frame to be moveable with respect to the frame. Further, the secondary grill segment may be moveable between an open position and a closed position with respect to the primary grill segment. The secondary grill segment may be configured to cover, in the closed position, a secondary windscreen of the operator cabin in a mounted state of the frame.

Advantageously, the pivotable mounting of the secondary grill segment on the operator cabin may allow easy access to the secondary windscreen and the primary windscreen through the secondary windscreen.

These and other features, aspects, and advantages of the present subject matter will be better understood with reference to the following description and appended claims. This summary is provided to introduce a selection of concepts. This summary is not intended to identify key features or essential features of the claimed subject matter, nor is it intended to be used for to limiting the scope of the claimed subject matter.

### BRIEF DESCRIPTION OF DRAWINGS

The detailed description is provided with reference to the accompanying figures. It should be noted that the description and the figures are merely examples of the present subject matter and are not meant to represent the subject matter itself.

FIG. 1 illustrates a side view of a working machine, in accordance with an example of the present subject matter.

FIG. 2 illustrates a secondary grill segment, in accordance with an example of the present subject matter.

FIG. 3 illustrates an exploded view of the secondary grill segment mounted on an operator cabin, in accordance with the example of the present subject matter.

FIG. 4A illustrates a perspective view of an operator cabin comprising the secondary grill segment in a closed position, in accordance with an example of the present subject matter.

FIG. 4B illustrates a perspective view of the operator cabin comprising the secondary grill segment in an open position, in accordance with an example of the present subject matter.

FIG. 4C illustrates another perspective view of the operator cabin comprising the secondary grill segment in the open position, in accordance with an example of the present subject matter.

FIG. 4D illustrates a front view of the operator cabin comprising the secondary grill segment in an open position, in accordance with an example of the present subject matter.

FIG. 5A illustrates a perspective view of a windscreen guard assembly, in accordance with an example of the present subject matter.

FIG. 5B illustrates an enlarged view of portion A of FIG. 5A, in accordance with an example of the present subject matter.

FIG. 5C illustrates another enlarged view of portion A of FIG. 5A, in accordance with an example of the present subject matter

FIG. 6A illustrates a front view of a windscreen guard assembly, in accordance with an example of the present subject matter.

FIG. 6B illustrates a left-hand-side view of the windscreen guard assembly, in accordance with an example of the present subject matter.

FIG. 6C illustrates a right-hand-side view of the windscreen guard assembly, in accordance with an example of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The present subject matter relates to aspects of a windscreen guard assembly in working machines, such as backhoe loaders, slew excavators, telescopic handlers, forklifts, and skid-steer loaders.

Working machines commonly include an operator cabin that may be inhabited by the operator of the working machine. The operator cabin may be equipped with control devices that the operator may control to operate the working machine and its attachments. The working machines are typically employed at locations such as construction sites, mines and quarries for operations such as digging trenches, moving heavy objects between ground and an elevated structure, moving soil, sand, rubble, and other such materials. Therefore, the working machines operate in an environment exposed to dirt and debris.

Generally, operator cabins are provided in the form of a substantially rigid enclosure to protect the operator and the control devices from the dirt and debris in the external environment. The enclosure may be provided with transparent windscreens, commonly made of toughened glass, at predetermined locations to allow the operator to view the surroundings during operation of the working machine. The windscreen may be provided on a front end, left side, right side, and on a rear end of the operator cabin to provide a thorough view of the conditions surrounding the working machine. However, often during operation of the working machine, unsolicited materials, such as soil and grime may fall and adhere to the windscreens, thereby obstructing the visibility of the operator operating the working machines. In certain cases, even heavy objects, such as debris, rocks, and the like may also fall on the windscreen causing damage to the windscreen. The impact of the heavy objects may be high enough to break the windscreen of the operator cabin and hurt the operator or may damage the equipment in the operator cabin. Therefore, the windscreens need to be protected, particularly, for the working machines that are employed in high-risk locations such as construction sites.

Conventionally, screen guards in the form of grill made of heavy materials, such as stainless steel, aluminum, iron, and the like may be affixed onto the operator cabin to shield the windscreen against impact from accidental falling of unsolicited heavy objects. The grill-structure of the conventional screen guards may thus sufficiently protect the windscreen and allow the operator to have adequate visibility of the surroundings. The screen guard may be bolted, i.e., fixedly coupled, onto the operator cabin. The bolting of the screen guards onto the operator cabin is however challenging due to the three-dimensional plane assembly of the front windscreen and the side windscreens. For instance, affixing the screen guard onto the operator cabin may require several subassembly steps such as welding, lifting, locating, and fastening of the screen guard on the operator cabin. Further, owing to the purpose of tolerating impact from heavy objects, the conventional screen guards are generally bulky and require significant effort to mount the heavy screen guards onto the operator cabin.

While the conventional screen guards may protect windscreens from a probable impact from accidental falling of heavy objects, the grill-structure of the conventional screen guards may still allow the dirt and grime to adhere onto the windscreen. Further, since the screen guards are bolted onto the operator cabin, it is not feasible to disassemble the screen guards to access the windscreen. Consequently, the windscreen glass cannot be cleaned properly to remove the dirt and grime which disrupts the visibility of the operator. In view of the bulky nature of the screen guards and the difficulties in the mounting and dismounting of the conventional screen guards, the serviceability and replacement of such components may also become non-viable.

To overcome the drawbacks discussed in the foregoing description, certain conventional screen guards are provided with a hinged coupling at a top portion of the operator cabin. The hinged coupling may allow the screen guard to pivot along a horizontal axis of the operator cabin to move in an upward direction with respect to a chassis of the working machine to open the screen guard and allow access to the windscreen. However, the hinged coupling at the top portion of the operator cabin requires actuation of the screen guard against the force of gravity. Therefore, an operator has to push the screen guard against the gravitational bias to attain movement in the upward direction with respect to the chassis of the working machine. Further, to effectuate such a motion, the operator has to climb onto an elevated structure to reach the screen guard and apply the required force against the gravitational pull. For example, the operator may climb onto the wheel of the working machine to access the screen guard and move it towards an open position. Therefore, providing a hinged coupling of the screen guard assembly at the top portion of the operator cabin reduces the accessibility of the windscreen. Additionally, accessing the screen guard by climbing on the elevated structure may have potential safety risks to the operator.

Additionally, once the screen guard is opened by pivoting along a horizontal axis with respect to the operator cabin, an additional biasing force would be required to hold the screen guard in the open position. Therefore, an additional tensioning component, for instance, hydraulic cylinders, spring mechanism, and the like may have to be provisioned to retain the screen guard in the open position. The provisioning of such additional tensioning component would incur additional cost and complexity in installation and maintenance of the screen guard assembly.

According to examples of the present subject matter, windscreen guard assembly for a working machine is described.

The windscreen guard assembly may be mounted to an operator cabin of the working machine to shield the windscreen of the operator cabin against impact from accidental falling of heavy objects. The operator cabin may be provided with a primary windscreen to provide the operator with a view of the environment ahead of the working machine, and a secondary windscreen adjacent to the primary windscreen. The secondary windscreen may allow the operator to view the environment on either side of the working machine. The windscreen guard assembly, as disclosed in the present subject matter, may include a primary grill segment that may cover the primary windscreen and secondary grill segments that may cover the secondary windscreens of the operator cabin. The primary grill segment and the secondary grill segment may be provided as separate components that may be individually mounted at appropriate portions on the operator cabin to cover the windscreen of the working machine. As a result, the windscreen guard assembly of the present subject matter is less bulky in nature and exhibit a modular structure. The modular design of the windscreen guard assembly allows for robust protection against impacts without compromising visibility, which is paramount for operator safety. The windscreen guard assembly, being modular, may be assembled in less time and with less complexity than the conventional screen guards regardless of the three-dimensional plane assembly of the primary windscreen and the secondary windscreen. Additionally, if one portion of the windscreen guard assembly is damaged and needs replacement, the modularity in the design of the windscreen guard assembly allows easy serviceability and replacement of components in a cost-effective manner.

In an example implementation, the primary grill segment may be fixedly coupled with the operator cabin to cover the primary windscreen. Further, the secondary grill segment may be pivotably mounted on the operator cabin and moveable between an open position and a closed position with respect to the primary grill segment. In operation, the secondary grill segment, in the open position, may move away from the primary grill segment to uncover the secondary windscreen. The uncovered secondary windscreen may thus be accessible to an operator or another working personnel for cleaning the secondary windscreen to remove the dirt and grime adhering thereto. Additionally, the operator of the working machine or the another working personnel may also be able to access the primary windscreen adjacent to the secondary windscreen through the uncovered secondary windscreen.

In an example, the secondary grill segment may be pivotably mounted to the operator cabin by a hinge assembly. The hinge assembly may include a first hinged coupling between the grated structure and the operator cabin and a second hinged coupling between the weight-distribution structure and the operator cabin. The positioning of the hinge assembly in the present example allows the secondary grill segment to pivot sideways with respect to the secondary grill segment. Therefore, the pivoting movement need not be performed against the gravitational pull and a smooth transition between an open position and a closed position may be achieved for the secondary grill segment. Further, the requirement of any additional tensioning or biasing components, such as hydraulic cylinders, spring mechanism, and the like, to retain the secondary grill segment in an open position, against the gravitational pull, may be eliminated.

In another example implementation of the present subject matter, a windscreen guard assembly may be mounted on a frame. The frame may be mountable on the operator cabin. The primary grill segment and the secondary grill segment of the windscreen guard assembly may have similar configuration as the primary grill segment and the secondary grill segment directly mounted on the operator cabin of the working machine, as elucidated above. In the present example implementation, the frame, having the primary grill segment and the secondary grill segment mounted thereon, may be directly mounted on the operator cabin in a manner that the primary grill segment covers a primary windscreen, and the secondary grill segment covers the secondary windscreen. In the present example implementation, the sub-assembly steps required to mount the windscreen guard assembly at an installation site are significantly reduced.

Further, the pivotable coupling of the secondary grill segment with the operator cabin allows the secondary grill segment to be easily accessed for cleaning the windscreen and allow better visibility to the operator. Furthermore, the windscreen guard assembly may be designed in a modular configuration to provide non-bulky components for mounting on the windscreen of a working machine. In the same vein, the different components of the windscreen guard assembly may be easily disassembled for serviceability or replacement. Additionally, the secondary grill segment may be accessed without the requirement to climb on an elevated structure to reach the handle, thereby allowing safer operating conditions.

The above aspects are further illustrated in the figures and described in the corresponding description below. It should be noted that the description and figures merely illustrate principles of the present subject matter. Therefore, various arrangements that encompass the principles of the present subject matter, although not explicitly described or shown herein, may be devised from the description and are included within its scope.

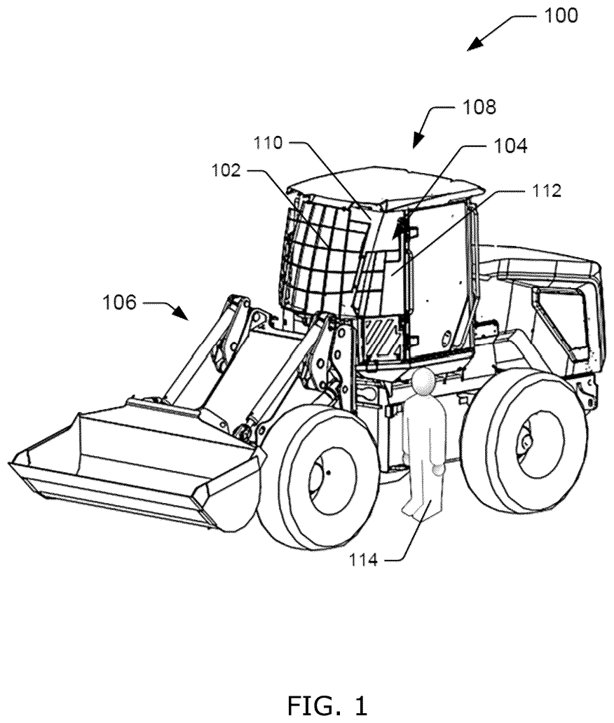

FIG. 1 illustrates a side view of a working machine 100, in accordance with an example of the present subject matter. Examples of the working machine 100 may include, but are not limited to, front-end loaders, backhoe loaders, slew excavators, telescopic handlers, forklifts, and skid-steer loaders, for moving loads.

As illustrated in FIG. 1, the working machine 100 may comprise a primary grill segment 102 and a secondary grill segment 104 mounted thereto. The working machine 100 may be a front-end loader equipped with a working arm 106 and an operator cabin 108. The operator cabin 108 may be inhabitable by an operator and may include an operator seat (not shown) and control devices (not shown), for example, but not limited to, a steering wheel, a foot brake, a foot throttle, a handle throttle, a working arm control lever, and the like. The operator cabin 108 may be mounted onto a chassis (not shown) of the working machine 100. The operator cabin 108 may include a housing, generally, formed as a rigid enclosure to protect the operator during operation of the working machine 100. The operator cabin 108 may further include windscreens, commonly made of heavy transparent material, for example, toughened glass, disposed along a front end, a rear and, and on either side of the operator cabin 108 to provide visibility to the operator while operating the working machine 100 and its attachments, for example, the working arm 106. In an example, the windscreen on a front end of the working machine 100, above the working arm 106, may be referred to as a primary windscreen 110. In the example, a windscreen may also be provided on either side of the operator cabin 108 to allow the operator to view the environment on either side of the working machine 100. The windscreen disposed on the sides of the working machine 100, adjacent to the primary windscreen 110, may be referred to as secondary windscreen 112.

The primary grill segment 102 and a secondary grill segment 104 may be mounted on the working machine 100 to cover the primary windscreen 110 and the secondary windscreen 112, respectively. The primary grill segment 102 and the secondary grill segment 104 may thus protect the primary windscreen 110 and the secondary windscreen 112, respectively, from accidental impact due to falling of heavy objects such as debris, and the like on the windscreens.

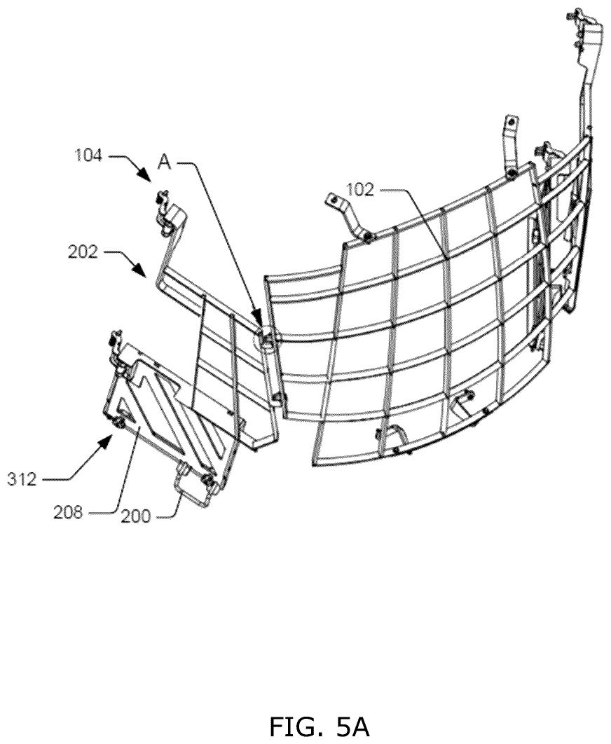

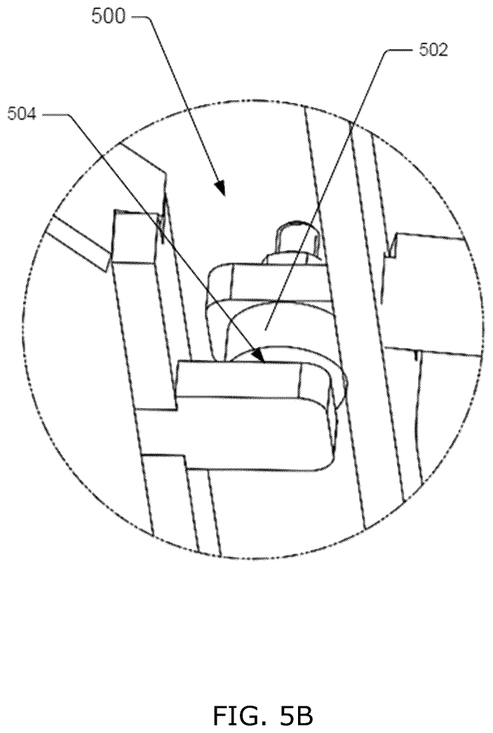

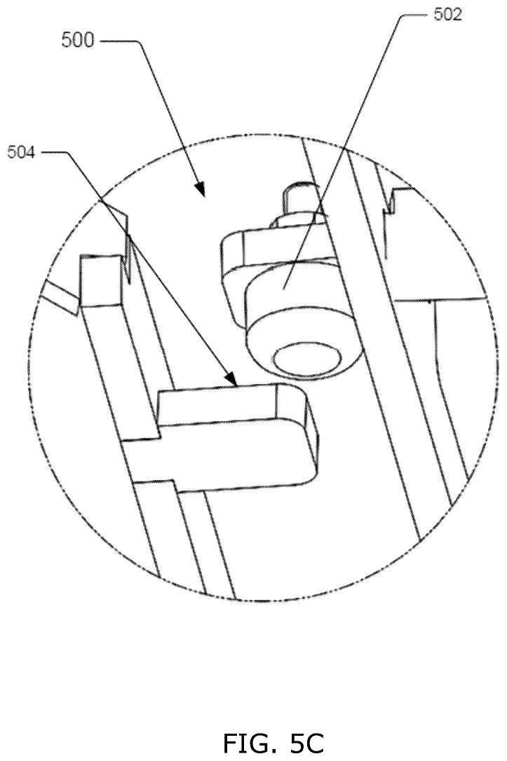

In an example, the primary grill segment 102 may be mounted to the operator cabin 108 to cover the primary windscreen 110. The primary grill segment 102 may be affixed onto the operator cabin 108, for example, but not limited to, using conventional nut and bolt fastening mechanism. The primary grill segment 102 may further include a bump stopper (shown in FIGS. 5A-5C) that protects the primary grill segment 102 at a point where primary grill segment 102 may interface with the secondary grill segment 104.

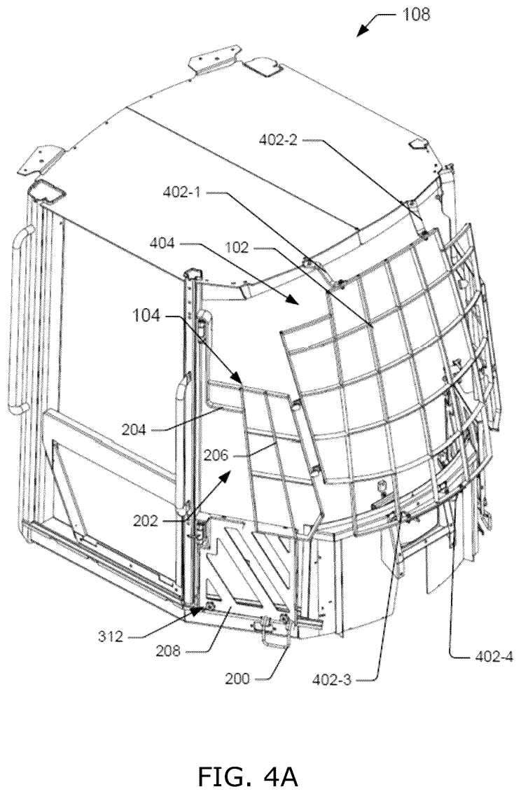

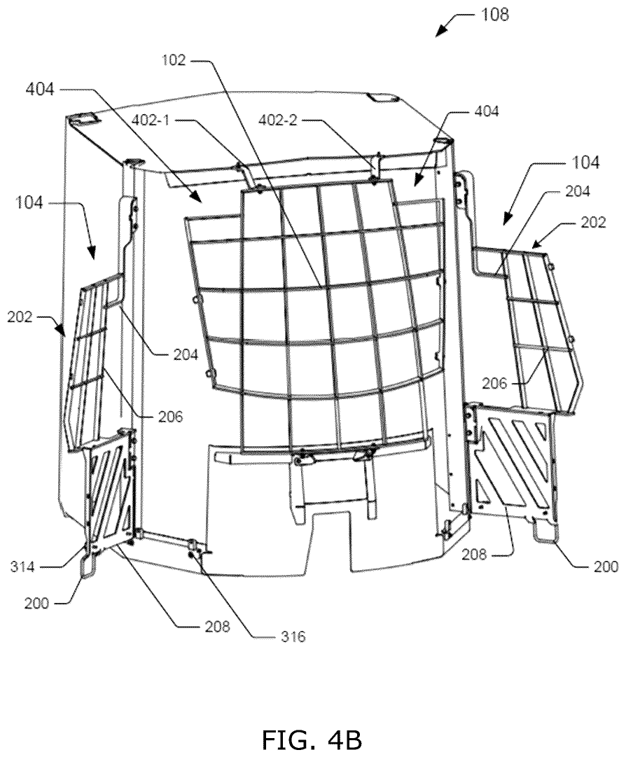

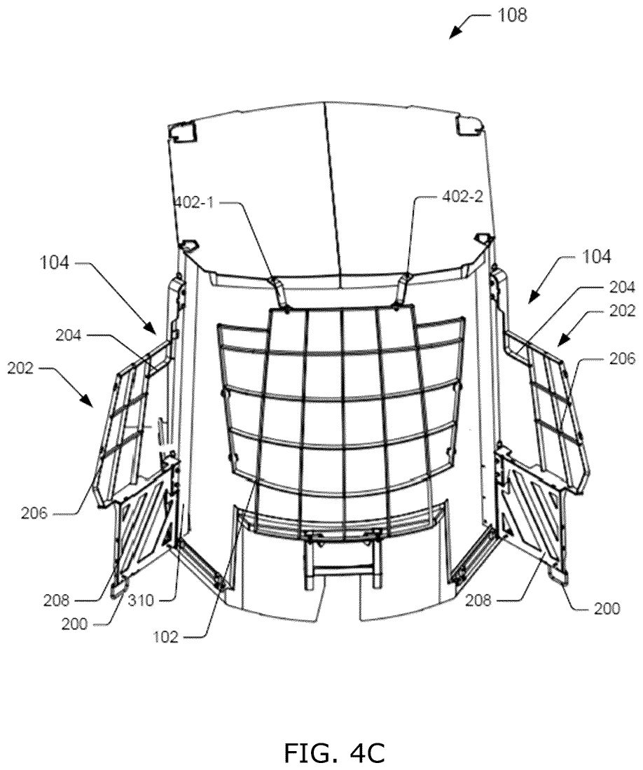

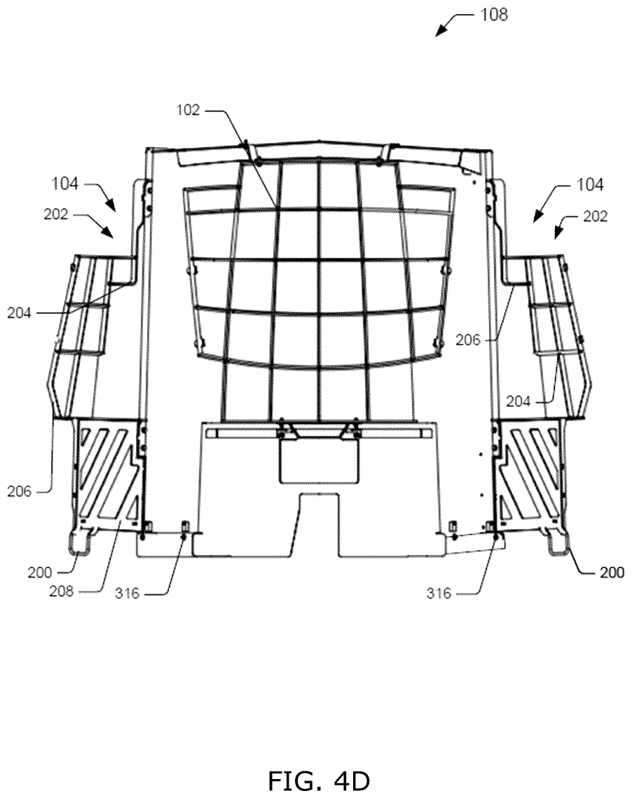

Further, the secondary grill segment 104 may be pivotably mounted to the operator cabin 108 and may be movable between an open position (not shown) and a closed position with respect to the primary grill segment 102. The secondary grill segment 104 may cover the secondary windscreen 112, in a closed position, as depicted in FIG. 1. The secondary grill segment 104 may be easily accessed by an operator, for example, by an operator 114 to pivot the secondary grill segment 104 between the open position (shown in FIGS. 4B-4D) and the closed position (shown in FIG. 1 and FIG. 4A), while standing on the ground, as will be explained later. Therefore, the operator 114 may not have to climb an elevated structure to actuate the pivotable movement of the secondary grill segment 104.

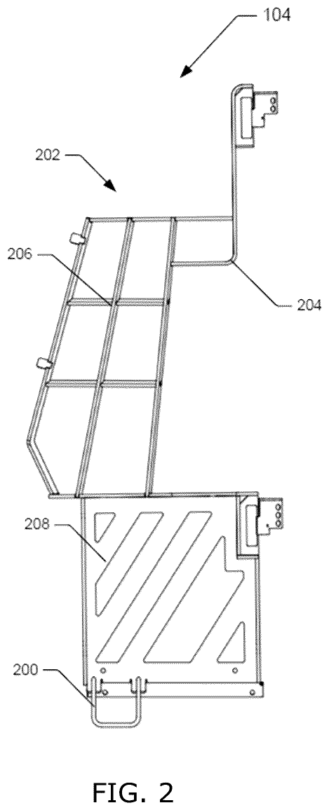

FIG. 2 illustrates the secondary grill segment 104, in accordance with an example of the present subject matter. As discussed above, the secondary grill segment 104 may be pivotably mounted onto operator cabin 108 of a working machine 100 to uncover a secondary windscreen 112 in an open position and cover the secondary windscreen 112 in a closed position. The secondary grill segment 104 may include a handle 200 to operate the secondary grill segment 104 between the open position and the closed position. The handle 200 may be operable by an operator to allow the operator to open, close, or otherwise manipulate the secondary grill segment 104. The handle 200 may transmit force that may be applied by the operator to manipulate the secondary grill segment 104 between the open position and the closed position. The handle 200 may be formed as a loop member retractable with respect to the secondary grill segment 104. In an example, the loop member may slide into a recess within the secondary grill segment 104 when not in use. The loop configuration of the handle 200 provides the handle 200 as an easily graspable element, potentially improving comfort and reducing strain during operation. Further, the handle 200 being retractable may provide a compact and streamlined profile when the handle 200 is not in use, thereby reducing protrusions and potential snag points. When needed, the loop can be extended to offer a large, ergonomic gripping surface for operating the secondary grill segment 104.

The handle 200 may be coupled to the secondary grill segment 104 to operate the secondary grill segment 104 between the open position (shown in FIGS. 4B-4D) and the closed position (shown in FIG. 1 and FIG. 4A) with respect to the primary grill segment 102. In an example implementation, the handle 200 may be coupled at a portion of the secondary grill segment 104 that may be easily grasped by an operator to operate the secondary grill segment 104 between the open position and the closed position. The handle 200 may be provided at a distal edge of the secondary grill segment 104. The distal edge may be an edge of the secondary grill segment 104 away from an edge that is to pivotably mount the secondary grill segment 104 to the operator cabin 108. By providing the handle 200 at the distal edge, the moment of torque transmitted to the pivotable mounting may be high for allowing easy pivoting of the secondary grill segment 104 between the open and the closed position. As a result, the operator may have to provide less torque on the handle 200 than needed for pivoting the secondary grill segment 104 if the handle 200 were provided in proximity to the edge of pivotable mounting.

For example, the handle 200 may be coupled at a lower end of the secondary grill segment 104. The lower end of the secondary grill segment 104 may be in proximity to a chassis of the working machine 100. In other words, the handle 200 may be provided close to the ground to allow the operator to easily grasp the handle 200 without the need to climb on an elevated structure to access the secondary grill segment 104.

The secondary grill segment 104 may further include a grated structure 202. The grated structure 202 may substantially cover the secondary windscreen 112 in the closed position. The grated structure 202 may include a connecting section 204 and a grill section 206 offset from the connecting section 204. The connecting section 204 may pivotably mount the secondary grill segment 104 to the operator cabin 108. In an example, the connecting section 204 may be provisioned with slots to mount a portion of the pivotable coupling between the secondary grill segment 104 and the operator cabin 108. Further, an edge of the grill section 206 may be offset from an edge of the connecting section 204. The grill section 206 may be formed as a mesh of spaced longitudinally extending bars, parallel to each other, and transversely extending bars forming a grid structure with the longitudinally extending bars. Providing the edge of grill section 206 offset from the connecting section 204 allows a wider visibility for the operator and a lower weight of the grated structure 202. The grill section 206 may cover the secondary windscreen 112 in the closed position. The spacing between the bars of the grill section 206 may be wide enough to provide visibility through the secondary windscreen 112, when the secondary grill segment 104 is in the closed position, and narrow enough to intercept any heavy object that may accidently fall on the secondary windscreen 112. Therefore, providing the grill section 206 may allow robust protection for the secondary windscreen 112 against impacts from debris while maintaining operator's field of view which is crucial for safe and efficient operation.

The secondary grill segment 104 may be provided with variable weight distribution by provisioning of a weight-distribution structure 208 contiguous to the grated structure 202. In an example, the weight-distribution structure 208 may be provided contiguous to the grill section 206. The weight-distribution structure 208 may be designed to and positioned with respect to the grated structure 202 to regulate a position of a center of gravity (CG) of the secondary grill segment 104. For instance, the characteristics related to the design and the positioning of the weight-distribution structure 208 may adjust the CG of the entire structure of the secondary grill segment 104 to be regulated and positioned at a location that facilitates easy operation of the secondary grill segment 104 between the open position and the closed position. For example, the weight-distribution structure 208 may have a greater mass than the grated structure 202. In another example, the regulation of the CG may be achieved by consideration of the size and the mass of the weight-distribution structure 208. Controlling a position of the CG may provide the flexibility of providing the CG in proximity to a point from where an operator may grasp the secondary grill segment 104 for pivoting between the open position and the closed position. As a result, an operator can easily access the secondary windscreen 112 behind the secondary grill segment 104 for regular cleaning and maintenance. The weight-distribution structure 208 may be configured to bias the secondary grill segment 104 in the closed position. For example, the weight-distribution structure 208 may provide a variable weight distribution to the secondary grill segment 104 such that the gravity assists in keeping the secondary grill segment 104 biased towards the closed position. Advantageously, the secondary grill segment 104 biased in the closed position may preventing accidental opening of the secondary grill segment 104 due to the vibrations experienced during operation of the working machine 100. The weight-distribution structure 208 may include a panel. In an example, the panel may have a perforated configuration, as shown in FIG. 2. In an example, the handle 200 may be provided as being coupled to the weight-distribution structure 208 allowing the operator to grasp the secondary grill segment 104 from a point in proximity to the CG thereby facilitating easy pivoting of the secondary grill segment 104.

Owing to the greater mass of the weight-distribution structure 208 in comparison with the grated structure 202, the CG of the entire secondary grill segment 104 may be positioned in proximity to the weight-distribution structure 208. Therefore, the weight-distribution structure 208 may, in an example, be strategically positioning contiguous to the first grate structure and in proximity to the handle 200 such that the CG is positioned in proximity to the handle 200. Positioning of the CG in proximity to the handle 200 significantly reduces the torque required to be applied on the handle 200 for pivoting the secondary grill segment 104 between the open position and the closed position. Further, positioning of the CG in proximity to the handle 200 ensures that the torque applied to the handle 200 to pivot the secondary grill segment 104 does not unevenly pull or push the secondary grill segment 104 even in the presence of variable weight distribution between the components of the secondary grill segment 104. For example, the grated structure 202, relatively lighter in mass in comparison with the weight distribution structure 208, may not bend unevenly in the event of pulling the handle 200 by applying a significant torque, and the secondary grill segment 104 may smoothly transition between the open position and the closed position.

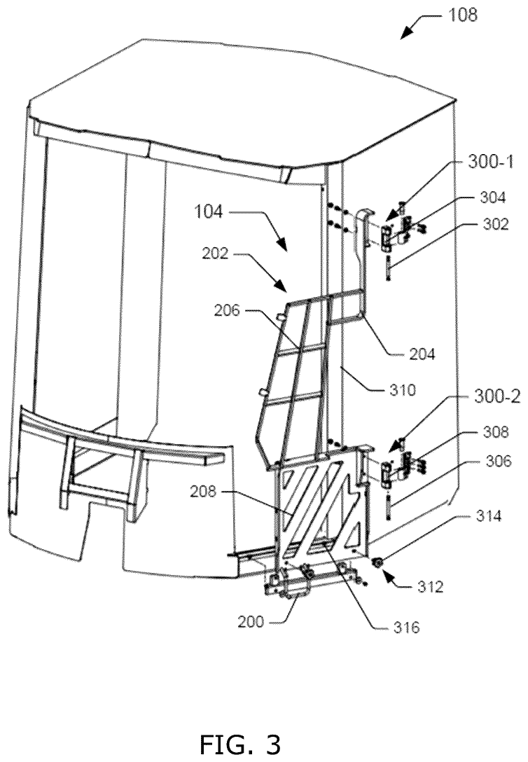

FIG. 3 illustrates an exploded view of the secondary grill segment 104 mounted on the operator cabin 108, in accordance with an example of the present subject matter. In the example implementation, the secondary grill segment 104 may be pivotably mounted to the operator cabin 108 by a first hinged coupling 300-1 and a second hinged coupling 300-2. The first hinged coupling 300-1 and a second hinged coupling 300-2 may be collectively referred to as a hinge assembly 300. The first hinged coupling 300-1 may be provided between the grated structure 202 and the operator cabin 108. Further, the second hinged coupling 300-2 may be provided between the weight-distribution structure 208 and the operator cabin 108. The first hinged coupling 300-1 may include a first hinge body 302 coupled to the grated structure 202. The first hinge body 302 may be received in a first receiving bracket 304 mounted on the operator cabin 108. In an example, the first receiving bracket 304 may be mounted adjacent to the secondary windscreen 112 and, particularly, adjacent to the first hinge body 302 on the grated structure 202.

The second hinged coupling 300-2 provided between the weight-distribution structure 208 and the operator cabin 108 may include a second hinge body 306 provided on the weight-distribution structure 208. The second hinge body 306 may be received in a second receiving bracket 308 mounted on the operator cabin 108.

As discussed above, the weight-distribution structure 208 may be provided contiguous to the grated structure 202 at a bottom portion of the grated structure 202. Alternatively, the weight-distribution structure 208 may be provided contiguous to the grated structure 202 at a top portion of the grated structure 202. The decision of the positioning of the weight-distribution structure 208 may be made based on the position from which an operator intends to pivot the secondary grill segment 104. In the example, when the weight distribution structure 208 is provided contiguous to the grated structure 202 at a bottom portion of the grated structure 202, the CG of the secondary grill segment 104 may be regulated and positioned between the second hinge body 306 and a midpoint of the first hinge body 302 and the second hinge body 306. Therefore, the CG of the secondary grill segment 104 may be positioned at a lower end of the secondary grill segment 104 such that the secondary grill segment 104 may be feasibly actuated by the operator while standing on the ground.

In an example, the secondary grill segment 104 may be pivotably mounted to the operator cabin 108 through an intermediate structure 310. In an example, the intermediate structure 310 may be a door post for a door of the operator cabin 108. The first receiving bracket 304 and the second receiving bracket 308 may be provided on the intermediate structure 310.

The secondary grill segment 104 may detachably engage with the operator cabin 108 by a fastening mechanism 312. The fastening mechanism 312 may be provided between the weight-distribution structure 208 and the operator cabin 108. The fastening mechanism 312 may allow the secondary grill segment 104 to be retained in the closed position during operation of the working machine 100 and accidental opening of the secondary grill segment 104 may be prevented. Further, the fastening mechanism 312 provided on the weight-distribution structure 208 may prevent bending of the secondary grill segment 104 as the point of fastening would be in proximity to the CG of the secondary grill segment 104. Additionally, the weight-distribution structure 208 may be positioned in proximity to a location where an operator operates the secondary grill segment 104. Therefore, providing the fastening mechanism on the weight-distribution structure 208 would ensure easy accessibility for the operator for fastening/unfastening the secondary grill segment 104 and the operator cabin 108.

In an example, the fastening mechanism 312 may be provided in proximity to the handle 200 of the secondary grill segment 104. The threaded member may be easily accessed by an operator for fastening/unfastening the weight-distribution structure and the operator cabin. The fastening mechanism 312 may be provided on the secondary grill segment 104 at a lower edge of the secondary grill segment 104. The lower edge may be an edge of the secondary grill segment 104 in proximity to the chassis. Advantageously, the fastening mechanism 312 may be easily accessed by an operator for fastening/unfastening the weight-distribution structure 208 and the operator cabin 108. The fastening mechanism 312 may comprise a threaded member 314 and a threaded receptacle 316. The threaded member 314 may be rotatably insertable through the weight-distribution structure 208 and the operator cabin 108. Further, the threaded receptacle 316 may engage with threads of the threaded member 314. The threaded receptacle 316 may be provided on at least one of the weight-distribution structure 208 and the operator cabin 108 depending on the positioning of the corresponding threaded member 314 insertable in the threaded receptacle 316.

FIG. 4A illustrates a perspective view of the operator cabin 108 comprising the secondary grill segment 104 in a closed position, in accordance with an example of the present subject matter. FIG. 4B illustrates a perspective view of the operator cabin 108 comprising the secondary grill segment 104 in an open position, in accordance with an example of the present subject matter. FIG. 4C illustrates another perspective view of the operator cabin 108 comprising the secondary grill segment 104 in the open position, in accordance with an example of the present subject matter. FIG. 4D illustrates a front view of the operator cabin 108 comprising the secondary grill segment 104 in the open position, in accordance with an example of the present subject matter. For the sake of brevity, FIGS. 4A-4D have been explained in conjunction with each other.

As illustrated in FIG. 4A, the secondary grill segment 104 may be abutted with the primary grill segment 102 in a closed position by virtue of a bump stopper at an interface of the primary grill segment 102 and the secondary grill segment 104. While FIG. 4A depicts the secondary grill segment 104 as abutted with the primary grill segment 102, the secondary grill segment 104 may also be butted with the operator cabin 108, in another example. As can be seen from FIG. 4A, the primary grill segment 102 and the grated structure 202 of the secondary grill segment 104 adequately cover the primary windscreen 110 and the secondary windscreen 112 to prevent damage in case of impacts due to accidental falling of heavy objects on the operator cabin. Further, the primary grill segment 102 may be offset with the primary windscreen 110, in a three-dimensional plane, such that there remains a gap between the primary grill segment 102 and the primary windscreen 110. The gap may prevent strains on the primary windscreen 110 by avoiding contact between the primary grill segment 102 and the primary windscreen 110 as a result of shocks and vibrations experienced during day-to-day operations of the working machine.

The primary grill segment 102 may be coupled to the operator cabin 108 through a plurality of mounting brackets, for example, a first mounting bracket 402-1 and a second mounting bracket 402-2 at an upper edge of the primary grill segment 102 and a third mounting bracket 402-3 and a fourth mounting bracket 402-4 positioned at a lower edge thereof. The first mounting bracket 402-1, second mounting bracket 402-2, third mounting bracket 402-3, and fourth mounting bracket 402-4 may be collectively referred to as mounting brackets 402 and individually as mounting bracket 402. The mounting brackets 402 may be engageable with the operator cabin 108 for fixedly mounting the primary grill segment 102 to the operator cabin 108. The mounting brackets 402 may be integrated with the primary grill segment 102 and may be laterally distributed on at least one of the upper edge and lower edge of the primary grill segment 102. The lateral distribution of the mounting brackets 402 provides improved stability and load distribution across a wider area thereby allowing balanced mounting of the primary grill segment 102 on the operator cabin 108. In an example, the mounting brackets 402 may be Z-shaped mounting brackets providing adequate gap between the primary windscreen 110 and the primary grill segment 102 to allow the primary windscreen 110 to be easily accessed from the secondary windscreen 112. Further, the Z-shaped mounting brackets provide three-dimensional support and may resist twisting and lateral forces during operation of the working machine 100 having the primary grill segment 102 mounted thereto.

The primary grill segment 102 may include a cut-out 404 formed at each upper corner thereof. The cut-out 404 may allow positioning of headlamps on the operator cabin 108. Further, a vertical dimension of the secondary grill segment 104 may be less than a vertical dimension of the primary grill segment 102. The vertical dimension may be measured along a direction of offset between points of pivotable mounting between the secondary grill segment 104 and the operator cabin 108. In an example, the direction of offset is a direction of separation between the first hinged coupling 300-1 and the second hinged coupling 300-2 of the hinge assembly 300 providing pivotable mounting between the secondary grill segment 104 and the operator cabin 108. The vertical dimension of the secondary grill segment 104 being lesser than the vertical dimension of the primary grill segment 102 allows a space to remain over, for example, the grill section 206, to allow positioning of the rear view mirrors to assist the operator during operation of the working machine.

In operation, an operator intending to clean the windscreens may access the handle 200 coupled to the secondary grill segment 104. In an example, the operator may be operator 114 as depicted in FIG. 1. the operator may apply torque on the handle 200 and pivot the secondary grill segment 104 towards an open position (as shown in FIGS. 4B-4D), thereby uncovering the secondary windscreen 112. The operator may thus access the secondary windscreen 112 for cleaning. Further, the operator may also access the primary windscreen 110, for cleaning, through the gap between the primary grill segment 102 and the primary windscreen 110. As discussed above, since the weight-distribution structure 208 is designed and positioned to position the CG in proximity to the handle 200, the operator may feasibly pivot the secondary grill segment 104 between the open position and the closed position. Further, since the primary grill segment 102 to cover the primary windscreen 110 and the secondary grill segment 104 to cover the secondary windscreen 112 are provided as separate components, the mounting, maintenance, and serviceability of the individual components may be easier as each component, individually, may be compact. The primary grill segment 102 and the secondary grill segment 104 may comprise a bump stopper (shown in FIGS. 5A-5C) positioned at an interface therebetween.

FIG. 5A illustrates a perspective view of a windscreen guard assembly, in accordance with an example of the present subject matter. FIG. 5B illustrates an enlarged view of portion A, in accordance with the example of the present subject matter. FIG. 5C illustrates an enlarged view of portion A, in accordance with another example of the present subject matter. The bump stopper 500 may protect the primary grill segment 102 from impacts while also providing a surface that the operator can use to “bump” and align the primary grill segment 102 and the secondary grill segment 104. The bump stopper 500 may act as a cushioning mechanism, absorbing shock and reducing wear on an interface of the primary grill segment 102 and the secondary grill segment 104. The bump stopper 500 may be formed by providing a projection on the secondary grill segment that may abut against a bush 502. The bush 502 along with a projection 504 on the secondary grill segment 104 provides the bump stopper 500 that allows significant damping effect and prevents the secondary grill segment 104 from hitting the glass of the secondary windscreen 112. Therefore, the bump stopper 500 may significantly extend the lifespan of the primary grill segment 102 and the secondary grill segment 104 by minimizing mechanical stress and potential damage from repeated opening and closing of the secondary grill segment 104. The bump stopper 500 may also provide a defined limit to the range of motion of the secondary grill segment 104, preventing the secondary grill segment 104 from hitting one of the primary windscreen 110 and secondary windscreen 112. Additionally, the bump stopper 500 may aid in retaining the secondary grill segment 104 in the closed position during operation of the working machine and allows maintaining accurate positioning or alignment of the secondary grill segment 104 with respect to the primary grill segment 102. FIG. 5B illustrates the bump stopper 500 in a closed configuration where the projection 504 is received in the bush 502. Further, FIG. 5C illustrates the bump stopper 500 in an open configuration where the projection 504 is not received in the bush 502.

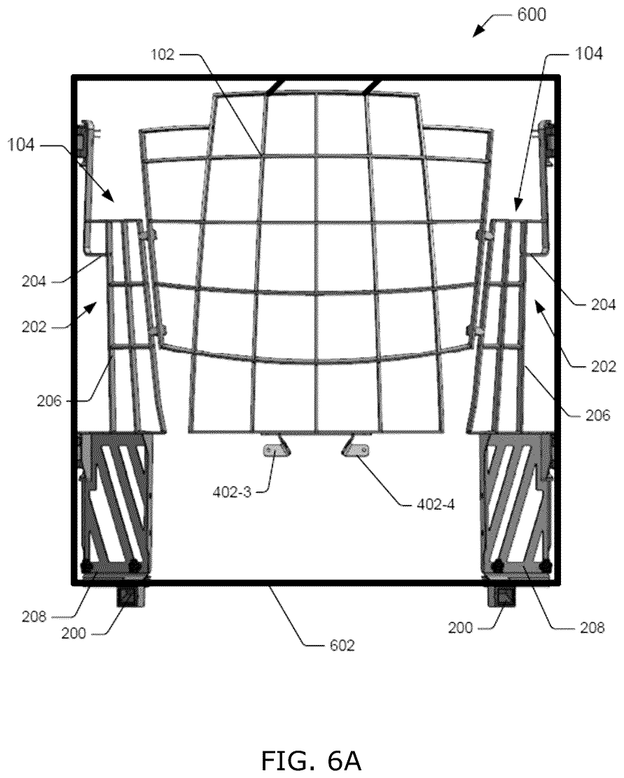

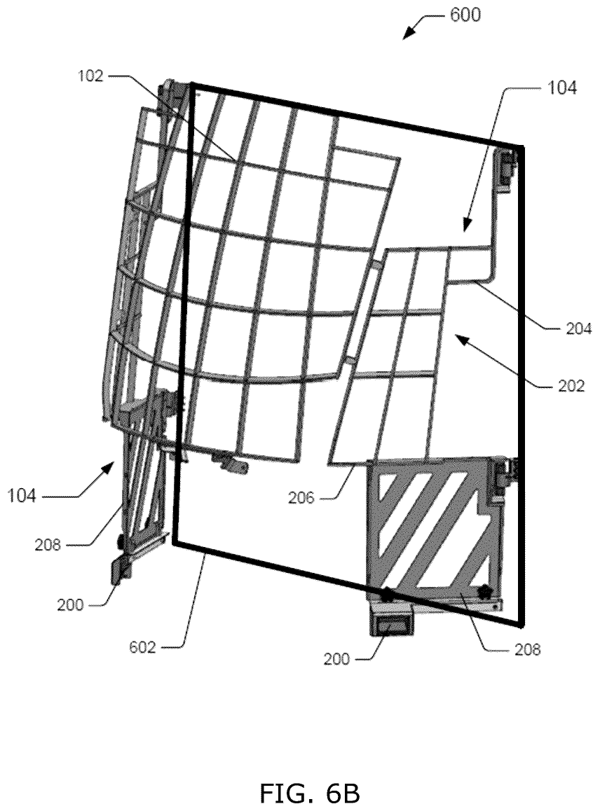

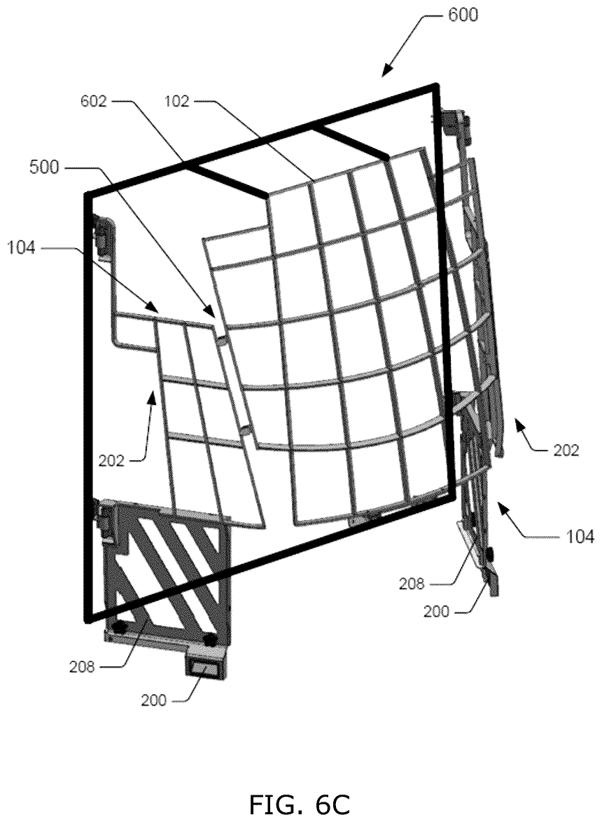

FIG. 6A illustrates a front view of a windscreen guard assembly 600, in accordance with an example of the present subject matter. FIG. 6B illustrates a left-hand-side view of the windscreen guard assembly 600, in accordance with an example of the present subject matter. FIG. 6C illustrates a right-hand-side view of the windscreen guard assembly 600, in accordance with another example of the present subject matter. For the sake of brevity, FIGS. 6A-6C have been explained in conjunction with each other.

In an example, as illustrated in FIGS. 6A-6C, the primary grill segment 102 and the secondary grill segment 104 may be mounted onto a frame 602. The frame 602, having the primary grill segment 102 and the secondary grill segment 104 mounted thereupon, may be mounted onto the operator cabin 108 of a working machine, such as the working machine 100. For example, the primary grill segment 102 and the secondary grill segment 104 may be welded onto the frame 602. In an example implementation, the frame 602, the primary grill segment 102 and the secondary grill segment 104 may be formed in a unitary structure. The frame 602 comprising the primary grill segment 102 and the secondary grill segment 104 may be referred to as a windscreen guard assembly 600.

In an example implementation, the frame 602 may comprise longitudinal bars connected together, at predetermined angles, to form a polygonal structure. The dimensions of the frame 602 and the predetermined angles may be selected to correspond with a three-dimensional plane assembly of the operator cabin 108 upon which the frame 602 may mounted. The primary grill segment 102 may be formed in a first portion of the frame 602 and a secondary grill segment 104 may be disposed in a second portion of the frame 602. The secondary grill segment 104 may have a similar structure as discussed in relation to FIGS. 1 to 5C In the present example implementation, the secondary grill segment 104 may be pivotably mounted to the frame 602 and may be openable with respect to the frame 602. The secondary grill segment 104 being pivotably mounted to the frame 602 to be moveable with respect to the frame 602 between an open position and a closed position with respect to the primary grill segment 102. The secondary grill segment 104 is configured to cover, in the closed position, a secondary windscreen of the operator cabin 108 in a mounted state of the frame 602.

The pivotable mounting of the secondary grill segment 104 onto the frame 602 may be effectuated by a hinged coupling between the secondary grill segment 104 and the frame 602. The hinged coupling between the secondary grill segment 104 and the frame 602 may be similar to the first hinged coupling 300-1 and the second hinged coupling 300-2, described in relation to FIG. 3. In the present example, a first hinged coupling, similar to first hinged coupling 300-1, may be provided between the grated structure 202 and the frame 602. Further, the second hinged coupling, similar to second hinged coupling 300-2, may be provided between the weight-distribution structure 208 and the frame 602.

The secondary grill segment comprises a handle. Similar to the handle 200 to operate the secondary grill segment 104 between the open position and the closed position with respect to the primary grill segment 102. The handle 200 may be formed as a loop member retractable with respect to the secondary grill segment 104. The handle 200 may be provided at a distal edge of the secondary grill segment 104, the distal edge being an edge of the secondary grill segment 104 away from an edge that is to pivotably mount the secondary grill segment 104 to the frame 602.

The handle 200 may be coupled to the secondary grill segment at a lower edge thereof. The lower edge may be an edge of the secondary grill segment 104 in proximity to the chassis in the mounted state of the frame 602. By providing the handle 200 at the lower edge of the secondary grill segment 104, the operator may easily grasp the handle 200 while standing on the ground and without climbing upon an elevated structure to access the secondary grill segment 104 in the mounted state of the frame 602.

The primary grill segment 102 and the secondary grill segment 104 may comprise a bump stopper 500 positioned at an interface therebetween. The bump stopper 500 may act as a cushioning mechanism, absorbing shock and reducing wear on an interface of the primary grill segment 102 and the secondary grill segment 104. The bump stopper 500 may significantly extend the lifespan of the primary grill segment 102 and the secondary grill segment 104 by minimizing mechanical stress and potential damage from repeated opening and closing of the secondary grill segment 104. The bump stopper 500 may also provide a defined limit to the range of motion of the secondary grill segment 104, preventing the secondary grill segment 104 from hitting one of the primary windscreen 110 and secondary windscreen 112 in the mounted state of the frame 602. Additionally, the bump stopper 500 may aid in retaining the secondary grill segment 104 in the closed position during operation of the working machine and allows maintaining accurate positioning or alignment of the secondary grill segment 104 with respect to the primary grill segment 102.

A vertical dimension of the secondary grill segment 104 may be less than a vertical dimension of the primary grill segment 102. The vertical dimension may be measured along a direction of offset between points of pivotable mounting between the secondary grill segment 104 and the frame 602. The smaller vertical segment may allow space for installing rear view mirrors on the operator cabin 108 in a mounted state of the frame 602 and also provide a clear view of the rear-view mirrors to the operator.

The secondary grill segment 104 may include a grated structure 202 to substantially cover the secondary windscreen 112 in the closed position of the secondary grill segment 104 in the mounted state of the frame 602.

The grated structure 202 may include a connecting section 204 and a grill section 206 offset from the connecting section 204. The connecting section 204 may pivotably mount the secondary grill segment 104 to the frame 602. Further, the grill section 206 may include a mesh of spaced elongated bars arranged to form a grid structure to cover the secondary windscreen 112 in the closed position in the mounted state of the frame 602. The grill section 206 allows robust protection for the windscreen against impacts from debris while maintaining operator's field of view which is crucial for safe and efficient operation.

An edge of the grill section 206 may be offset from an edge of the connecting section 204. Providing the edge of grill section 206 offset from the connecting section 204 allows a wider visibility for the operator in the mounted state of the frame 602 and a lower weight of the grated structure 202.

The primary grill segment 102 may be coupled to the operator cabin 108 through a plurality of mounting brackets 402 positioned at an upper edge and a lower edge thereof. In an example, mounting brackets 402 may be engageable with the operator cabin 108 for fixedly mounting the primary grill segment 102 to the operator cabin. In the example, the mounting brackets 402 may be integrated with the primary grill segment 102 and may be laterally distributed at the upper edge of the primary grill segment 102. The lateral distribution provides improved stability and load distribution across a wider area thereby allowing balanced mounting of the primary grill segment 102 on the frame 602. Further, the mounting bracket 402 may increase the space between the primary windscreen and the primary grill segment 102 to allow the primary windscreen to be easily accessed from the primary grill segment 102 in the mounted state of the frame 602.

In another example, a plurality of mounting brackets 402 may be provided on the first portion of the frame 602 at an upper edge and a lower edge thereof. The mounting brackets 402 may be engageable with the operator cabin for fixedly mounting the primary grill segment 102 to the operator cabin in the mounted state of the frame 602.

The mounting brackets 402 may be integrated with the first portion of the frame 602 and may be laterally distributed at the upper edge of the frame 602. The lateral distribution provides improved stability and load distribution across a wider area thereby allowing balanced mounting of the first portion of the frame 602 on the operator cabin 108. Further, the mounting bracket 402 may increase the space between the primary windscreen and the primary grill segment 102 to allow the primary windscreen to be easily accessed from the primary grill segment 102 in the mounted state of the frame 602.

The primary grill segment 102 may include a cut-out 404 formed at each upper corner thereof. The cut-out 404 may allow positioning of headlamps on the operator cabin in the mounted state of the frame 602.

The secondary grill segment 104 may comprise a weight-distribution structure 208 contiguous to the grated structure 202. The weight-distribution structure 208 may be designed and positioned with respect to the grated structure to regulate a position of a center of gravity (CG) of the secondary grill segment 104. Advantageously, controlling a position of the CG may provide the flexibility of providing the CG in proximity to a point from where an operator may grasp the secondary grill segment 104 for pivoting between the open position and the closed position. As a result, an operator can easily access the secondary windscreen behind the secondary grill segment 104 for regular cleaning and maintenance in the mounted state of the frame 602.

A mass of the weight-distribution structure 208 may be greater than a mass of the grated structure 202. The greater mass of the weight-distribution structure 208 influences the CG to be localized in proximity of the weight-distribution structure 208. Thus, the greater mass of the weight-distribution structure 208 allows regulating the CG.

The weight-distribution structure 208 may bias the secondary grill segment 104 in the closed position. Therefore, the secondary grill segment 104 may be biased in the closed position thereby preventing accidental opening of the secondary grill segment 104, in the mounted state of the frame 602, during operation of the working machine.

The secondary grill segment 104 may comprise a handle 200. The handle 200 may be coupled to the weight-distribution structure 208.

The handle 200 may be positioned in proximity to the CG of the secondary grill segment 104. Providing the handle 200, that may be used by the operator to pivot the secondary grill segment, on the weight-distribution structure 208 and in proximity to the CG, allows the pivoting of secondary grill segment 104 to be achieved with low rotational torque.

The weight-distribution structure 208 may include a panel having a perforated configuration.

The secondary grill segment 104 may detachably engage with the frame by a fastening mechanism 312. The fastening mechanism 312 may be provided between the weight-distribution structure 208 and the frame 602. The fastening mechanism may allow the secondary grill segment 104 to be retained in the closed position during operation of the working machine and accidental opening of the secondary grill segment 104 may be prevented. Further, the fastening mechanism 312 being provided on the weight-distribution structure 208 may prevent bending of the secondary grill segment 104 as the point of fastening would be in proximity to the CG of the secondary grill segment 104. Additionally, the weight-distribution structure 208 would be positioned in proximity to a location where an operator operates the secondary grill segment 104. Therefore, providing the fastening mechanism 312 on the weight-distribution structure 208 would ensure easy accessibility by the operator for fastening.

The fastening mechanism 312 may be provided in proximity to a handle 200 of the secondary grill segment 104. The fastening mechanism may thus be easily accessed by an operator for fastening/unfastening the weight-distribution structure 208 and the frame 602.

The fastening mechanism 312 may be provided on the secondary grill segment 104 at a lower edge thereof, the lower edge being an edge of the secondary grill segment 104 in proximity to the chassis in the mounted state of the frame 602. The fastening mechanism 312 may be easily accessed by an operator for fastening/unfastening without climbing an elevated structure in the mounted state of the frame 602.

The fastening mechanism 312 may comprise a threaded member 314 and a threaded receptacle 316. The threaded member 314 may be rotatably insertable through the weight-distribution structure 208 and the frame 602. Further, the threaded receptacle 316 may engage with threads of the threaded member 314. The threaded receptacle 316 may be provided on one of the weight-distribution structure 208 and the frame 602.

The threaded member 314 may comprise a gripping member connected at a head of the threaded member 314 for rotation of the threaded member 314 with respect to the threaded receptacle 316. The threaded member 314 may thus be easily held by an operator for fastening/unfastening the weight-distribution structure 208 and the frame 602.

In view of the above, the windscreen guard assembly 600 may include, amongst others, the following aspects:

In an aspect, the windscreen guard assembly 600 includes a frame 602, a primary grill segment 102 formed in a first portion of the frame 602, and a secondary grill segment 104 disposed in a second portion of the frame 602. The frame 602 is mountable to an operator cabin of a working machine 100. The primary grill segment may be fixedly mounted to the frame 602 and the primary grill segment is to cover a primary windscreen 110 of the operator cabin 108 in a mounted state of the frame 602. The secondary grill segment 104 may be pivotably mounted to the frame to be moveable with respect to the frame 602 between an open position and a closed position with respect to the primary grill segment 102. The secondary grill segment 104 may be configured to cover, in the closed position, a secondary windscreen 112 of the operator cabin 108 in a mounted state of the frame 602.

In the aspect, the secondary grill segment 104 of the windscreen guard assembly 600 includes a handle 200 to operate the secondary grill segment 104 between the open position and the closed position with respect to the primary grill segment 102.

In the aspect, the handle 200 may be formed as a loop member retractable with respect to the secondary grill segment 104.

In the aspect, the handle 200 is provided at a distal edge of the secondary grill segment 104, the distal edge being an edge of the secondary grill segment 104 away from an edge that is to pivotably mount the secondary grill segment 104 to the frame 602.

In the aspect, the handle 200 is coupled to the secondary grill segment 104 at a lower edge thereof, the lower edge being an edge of the secondary grill segment 104 in proximity to a chassis in the mounted state of the frame 602.

In the aspect, the primary grill segment 102 and the secondary grill segment 104 comprise a bump stopper 500 positioned at an interface therebetween.

In the aspect, a vertical dimension of the secondary grill segment 104 is less than a vertical dimension of the primary grill segment 102, the vertical dimension being measured along a direction of offset between points of pivotable mounting between the secondary grill segment 104 and the frame 602.

In the aspect, the secondary grill segment 104 comprises a grated structure 202 to substantially cover, in the closed position, the secondary windscreen 112 of the operator cabin 108 in the mounted state of the frame 602.

In the aspect, the grated structure 202 comprises a connecting section 204 to pivotably mount the secondary grill segment 104 to the frame 602; and a grill section 206 offset from the connecting section 204, the grill section 206 including a mesh of spaced elongated bars arranged to form a grid structure to cover, in the closed position, the secondary windscreen 112 of the operator cabin 108 in the mounted state of the frame 602.

In the aspect, an edge of the grill section 206 is offset from an edge of the connecting section 204.

In the aspect, the primary grill segment 102 is fixedly mounted to the frame 602 through a plurality of mounting brackets 402 positioned at an upper edge and a lower edge thereof.

In the aspect, the plurality of mounting brackets 402 are integrated with the primary grill segment 102 and are laterally distributed at the upper edge of the primary grill segment 102.

In the aspect, the first portion of the frame 602 includes a plurality of mounting brackets 402 positioned at an upper edge or lower edge thereof. The plurality of mounting brackets 402 may engage with the operator cabin 108 for mounting the frame 602 to the operator cabin 108.

In the aspect, the plurality of mounting brackets 402 are integrated with the first portion of the frame 602 and are laterally distributed at the upper edge of the frame 602.

In the aspect, the primary grill segment 102 comprises a cut-out 404 formed at each upper corner thereof.

In the aspect, the secondary grill segment 104 comprises a weight-distribution structure 208 contiguous to the grated structure 202), wherein the weight-distribution structure 208 is designed and positioned with respect to the grated structure 202 to regulate a position of a center of gravity (CG) of the secondary grill segment 104.

In the aspect, a mass of the weight-distribution structure 208 is greater than a mass of the grated structure 202.

In the aspect, the weight-distribution structure 208 is to bias the secondary grill segment 104 in the closed position.

In the aspect, the secondary grill segment 104 comprises a handle 200. The handle 200 may be coupled to the weight-distribution structure 208.

In the aspect, the handle 200 is positioned in proximity to the CG of the secondary grill segment 104.

In the aspect, the weight-distribution structure 208 comprises a panel.

In the aspect, the panel comprises a perforated configuration.

In the aspect, the secondary grill segment 104 is detachably engageable with the frame 602 by a fastening mechanism 312, the fastening mechanism 312 being provided between the weight-distribution structure 208 and the frame 602.

In the aspect, the fastening mechanism 312 is provided in proximity to a handle 200 of the secondary grill segment 104.

In the aspect, the fastening mechanism 312 is provided on the secondary grill segment 104 at a lower edge thereof, the lower edge being an edge of the secondary grill segment 104 in proximity to a chassis in the mounted state of the frame 602.

In the aspect, the fastening mechanism 312 comprises a threaded member 314 rotatably insertable through the weight-distribution structure 208 and the frame 602; and a threaded receptacle 316 to engage with threads of the threaded member 314, the threaded receptacle 316 provided on at least one of the weight-distribution structure 208 and the frame 602.

In the aspect, the threaded member 314 comprises a gripping member connected at a head of the threaded member 314 head for rotation of the threaded member 314 with respect to the threaded receptacle 316.

In the aspect, the secondary grill segment 104 is pivotably mounted to the frame 602 by a hinge assembly 300. The hinge assembly 300 comprises a first hinged coupling 300-1 between the grated structure 202 and the frame 602, and a second hinged coupling 300-2 between the weight-distribution structure 208 and the frame 602 the first hinged coupling 300-1 comprises a first hinge body 302 coupled to the grated structure 202; and a first receiving bracket 304 on the frame 602, wherein the first receiving bracket 304 receives the first hinge body 302. The second hinged coupling 300-2 comprises a second hinge body 306 coupled to the weight-distribution structure 208; and a second receiving bracket 308 on the frame 602, wherein the second receiving bracket 308 receives the second hinge body 306.

In the aspect, the CG of the secondary grill segment 104 is regulated to be positioned between the second hinge body 306 and a midpoint between the first hinge body 302 and the second hinge body 306.

In view of the above aspects, the present subject matter discloses the primary grill segment 102 and the secondary grill segment 104 to shield the operator cabin 108 against probably impact due to accidental falling of heavy objects such as debris, rocks, and the like. The secondary grill segment 104 of the present subject matter may be pivotable with respect to the operator cabin 108 to allow access to the secondary windscreen 112 and the primary windscreen 110 through a gap, in a three-dimensional plane, between the primary windscreen 110 and the primary grill segment 102. Therefore, the windscreen may be feasibly accessed for cleaning. The primary grill segment 102 and the secondary grill segment 104 may be formed as separate units, that may be either separately mounted onto the operator cabin 108 directly, or onto a frame 602 mountable on the operator cabin 108. Presence of separate grill segments for covering the primary windscreen 110 and the secondary windscreens 112 reduces the efforts required to mounting the grill segments onto the operator cabin. Further, by allowing mounting of grill segments, rather than mounting a bulky grill in conventional techniques, the disassembly for replacement and serviceability may be viable. The secondary grill segment 104 may be provided with a weight-distribution structure 204 designed to, and positioned with respect to the grated structure 202 to localize the center-of-gravity in proximity to the handle 200. The localization of center-of-gravity in proximity to the handle significantly reduces the torque required by an operator in pivoting the secondary grill segment 104 between an open position and a closed position. Further, since the secondary grill segment 104 may open sideways with respect to the secondary windscreen 112, the torque need not be applied opposite to the gravitational pull and thus no tensioning mechanism is required to employed. Further, the handle 200 may be provided in proximity to the chassis of the secondary grill segment 104 so that the operator may operate the secondary grill segment to pivot between the open position and the closed position while standing on the ground. Therefore, the operation of pivoting the secondary grill segment 104 may be safer for the operator than the conventional techniques.

Although examples of the primary grill segment 102 and secondary grill segment 104 have been described in language specific to structural features and/or methods, it is to be understood that the appended claims are not limited to the specific features described. Rather, the specific features are disclosed as examples of the primary grill segment 102 and secondary grill segment 104.

1. A working machine comprising:
a chassis;
an operator cabin mounted to the chassis, the operator cabin comprising:
a primary windscreen; and
a secondary windscreen adjacent to the primary windscreen;
a primary grill segment to cover the primary windscreen, the primary grill segment fixedly mounted to the operator cabin; and
a secondary grill segment to cover the secondary windscreen, wherein the secondary grill segment is pivotably mounted to the operator cabin to uncover the secondary windscreen in an open position and cover the secondary windscreen in a closed position.

2. The working machine as claimed in claim 1, wherein the secondary grill segment comprises a handle to operate the secondary grill segment between the open position and the closed position with respect to the primary grill segment.

3. The working machine as claimed in claim 2, wherein the handle is formed as a loop member retractable with respect to the secondary grill segment.

4. The working machine as claimed in claim 2, wherein the handle is provided at a distal edge of the secondary grill segment, the distal edge being an edge of the secondary grill segment away from an edge that is to pivotably mount the secondary grill segment to the operator cabin.

5. The working machine as claimed in claim 4, wherein the handle is coupled to the secondary grill segment at a lower edge thereof, the lower edge being an edge of the secondary grill segment in proximity to the chassis.

6. The working machine as claimed in claim 1, wherein the primary grill segment and the secondary grill segment comprise a bump stopper positioned at an interface therebetween.

7. The working machine as claimed in claim 1, wherein a vertical dimension of the secondary grill segment is less than a vertical dimension of the primary grill segment, the vertical dimension being measured along a direction of offset between points of pivotable mounting between the secondary grill segment and the operator cabin.

8. The working machine as claimed in claim 1, wherein the secondary grill segment comprises a grated structure to substantially cover the secondary windscreen in the closed position of the secondary grill segment.

9. The working machine as claimed in claim 8, wherein the grated structure comprises:
a connecting section to pivotably mount the secondary grill segment to the operator cabin; and
a grill section offset from the connecting section, the grill section including a mesh of spaced elongated bars arranged to form a grid structure to cover the secondary windscreen in the closed position.

10. The working machine as claimed in claim 9, wherein an edge of the grill section is offset from an edge of the connecting section.

11. The working machine as claimed in claim 1, wherein the primary grill segment is coupled to the operator cabin through a plurality of mounting brackets positioned at an upper edge and a lower edge thereof, the plurality of mounting brackets being engageable with the operator cabin for fixedly mounting the primary grill segment to the operator cabin.

12. The working machine as claimed in claim 11, wherein the plurality of mounting brackets are integrated with the primary grill segment and are laterally distributed at the upper edge of the primary grill segment.

13. The working machine as claimed in claim 1, wherein the primary grill segment comprises a cut-out formed at each upper corner thereof.

14. The working machine as claimed in claim 8, wherein the secondary grill segment comprises a weight-distribution structure contiguous to the grated structure, wherein the weight-distribution structure is designed and positioned with respect to the grated structure to regulate a position of a center of gravity of the secondary grill segment.

15. The working machine as claimed in claim 14, wherein a mass of the weight-distribution structure is greater than a mass of the grated structure.

16. The working machine as claimed in claim 14, wherein the weight-distribution structure is to bias the secondary grill segment in the closed position.

17. The working machine as claimed in claim 14, wherein the secondary grill segment comprises a handle, the handle being coupled to the weight-distribution structure.

18. The working machine as claimed in claim 17, wherein the handle is positioned in proximity to the CG of the secondary grill segment.

19. The working machine as claimed in claim 14, wherein the weight-distribution structure comprises a panel.

20. The working machine as claimed in claim 1, wherein the secondary grill segment is pivotably mounted to the operator cabin through an intermediate structure on the operator cabin, the hinge assembly being provided on the intermediate structure.
